(19) United States
(12) Patent Application Publication
(10) Pub. No.: US 2017/0032601 A1
(43) Pub. Date: Feb. 2, 2017

(54) ACCESS CONTROL SYSTEM AND DATA PROCESSING METHOD THEREOF

(71) Applicants: BEIJING KUANGSHI TECHNOLOGY CO., LTD., Beijing (CN); PINHOLE (BEIJING) TECHNOLOGY CO., LTD., Beijing (CN)

(72) Inventors: Erjin ZHOU, Beijing (CN); Jianfei WANG, Beijing (CN); Qi YIN, Beijing (CN)

(21) Appl. No.: 14/983,058

(22) Filed: Dec. 29, 2015

(30) Foreign Application Priority Data
Jul. 31, 2015 (CN) 201510465025.3

(51) Int. Cl. G07C 9/00; G06K 9/00

(52) U.S. Cl. CPC G07C 9/00158; G06K 9/00288

(57) ABSTRACT

An access control system and a data processing method for the access control system are provided. The access control system includes: a collection device set corresponding to the access passage, for collecting a real-time information data of a target object; an identification device for identifying the target object based on the collected real-time information data and an user registration information of the access control system, and obtaining an identification result; a system control device for carrying out decision logic based on the identification result to generate a control instruction; an access operation device for controlling an operation of the access passage based on the control instruction generated by the system control device.

The present disclosure claims priority of Chinese Patent Application No. 201510465025.3 filed on Jul. 31, 2015, and the full texts of the above Chinese patent applications are incorporated by reference herein as part of the present disclosure.

### TECHNICAL FIELD

The present disclosure relates to a technical field of access security, more particularly, to an access control system and a data processing method of the access control system.

### BACKGROUND ART

A access control system usually relies on “separate” authentication means, such as access card, password, etc. This results in low level of security, inconvenience of operation and bad user experiences. For example, people without authority may open a door by way of stealing access card, password, etc. User needs to carry the access card all the time, or remember various access passwords, and is required to stop in front of the access control system to swipe the card or enter the password. Therefore, it is desirable to design a new type of access control system, which would be more secure and convenient.

As a security authentication method, biometrics has quickly developed. The typical biometric authentication includes: iris authentication, fingerprint authentication and face authentication. Since biometrics can not separated from the authenticated person and is unique, the biometrics greatly improves the security problem of some authentication methods and avoids, to a great degree, potential problems with access cards or passwords and the like stolen.

In the access control system based on iris authentication and fingerprint authentication, the access control system apparatus may be expensive and unstable due to the feature of biometrics. For example, a specific apparatus, which is expensive, is required in iris authentication to carry out iris collection, and the iris authentication is sensitive to a quality of the collected image, a distortion of which may greatly affect a performance of the access control system. Moreover, iris collection requires a person to be authenticated to cooperate for collecting iris data in a short range of for example 10 to 30 cm, which lowers the user experience. Fingerprint authentication is a contact authentication method, the fingerprint collection apparatus may be contacted frequently in the authentication environment of large density, which may lead to sanitation problem and is prone to cause user's aversion. The physical fingerprint left on the collection apparatus is possible to be stolen and duplicated, thereby increasing potential security hazard. Therefore, it is desirable to provide an access control system, making it possible to perform identity verification and access control, thereby enhancing the user experience.

### SUMMARY

Embodiments of the present disclosure provide an access control system and a data processing method for the access control system, which can safely and conveniently perform identity verification and access control based on a collected real-time information data of a target object, thereby a user experience is enhanced.

In a first aspect, an access control system is provided. The access control system may include: a collection device set corresponding to an access passage, for collecting real-time information data of a target object; a identification device for identifying the target object based on the collected real-time information data and a user registration information of the access control system, and obtaining an identification result; a system control device for executing a decision logic to generate a control instruction based on the identification result; access operation device for controlling an operation of the access passage based on the control instruction generated by the system control device.

In combination with the first aspect, in an implementation of the first aspect, the identification device may include: a face recognition module for carrying out face recognition for the target object based on the collected real-time information data and the user registration information of the access control system, to determine identity information of the target object.

In combination with the first aspect and its implementation above, in another implementation of the first aspect, the identification device may further include: a liveness detection module, for perform a liveness detection to determine whether the target object is a living body, based on the real-time information data.

In combination with the first aspect and its implementation above, in another implementation of the first aspect, the system control device may execute decision logic based on at least one of the liveness detection result of the liveness detection module and the face recognition result of the face recognition module. When the liveness detection result indicates that the target object is not a living body, the system control device may alter the access operation device. When the determined identity information indicates the identity of the target object and the liveness detection result indicates that the target object is not a living body, the system control device may send reminder information to a registered user corresponding to the determined identity information.

In combination with the first aspect and its implementation above, in another implementation of the first aspect, the identification result may comprise whether the target object is in a black list or a white list of the access control system, the system control device generating a control instruction for forbidding an open of the access passage in the case that the target object is within the black list of the access control system and/or generating a control instruction for permitting the open of the access passage in the case that the target object is within the white list of the access control system.

In combination with the first aspect and its implementation above, in another implementation of the first aspect, there are a plurality of access passages, and the identification device may obtain a access relevant information of the access passage corresponding to the target object, and transmitting the access relevant information to the system control device; the system control device may execute different decision logics for different access passages based on the access relevant information.

In combination with the first aspect and its implementation above, in another implementation of the first aspect, the system control device may execute different decision logics for different registered user of the access control system; and/or the system control device may always generate a control instruction for keeping the access passage closed during a specific period without executing decision logic based on the identification result.

In combination with the first aspect and its implementation above, in another implementation of the first aspect, the access operation device may include: an access controller for controlling a opening operation and a closing operation of the access passage based on the control instruction; a display for displaying at least one of the real-time operating information of the access passage, an information of the verified target object and a welcome information for the verified target object.

In combination with the first aspect and its implementation above, in another implementation of the first aspect, the displayed real-time operating information may include at least one of the following information: the real-time information data from the collection device or the identification device; the identification result from the identification device or the system control device.

In combination with the first aspect and its implementation above, in another implementation of the first aspect, the access control system may further include: a memory for storing the user registration information of the access control system; a system maintenance terminal for maintaining the user registration information and a control of the access operation device by the system control device.

In combination with the first aspect and its implementation above, in another implementation of the first aspect, the system maintenance terminal may include: an administrator module for changing the decision logic of the system control device, maintaining the information display of the access operation device, querying the user registration information and maintaining the user registration information; a user module for accessing a login information of a specific user and modifying an identity information of the specific user.

In a second aspect, a data processing method for an access control system is provided. The data processing method may include: collecting real-time information data of a target object; identifying the target object based on the collected real-time information data and an user registration information of the access control system, and obtaining an identification result; executing a decision logic to generate a control instruction based on the identification result; controlling an operation of the access passage based on the control instruction.

In combination with the second aspect, in one implementation of the second aspect, the identification of the target object based on the collected real-time information data may include: carrying out face recognition for the target object based on the collected real-time information data to determine the identity information of the target object.

In combination with the second aspect and its implementation above, in another implementation of the second aspect, the identification of the target object based on the collected real-time information data may further include: carrying out liveness detection for the target object based on the collected real-time information data to determine whether the target object is a living body.

In combination with the second aspect and its implementation above, in another implementation of the second aspect, the execution of decision logic based on the identification result to generate a control instruction may include at least one of the following operations: when the target object is not a living body, issuing an alert for prompting the presence of malicious users; and when the determined identity information indicates an identity of the target object and the liveness detection result indicates that the target object is not a living body, sending reminder information to a registered user corresponding to the determined identity information.

In combination with the second aspect and its implementation above, in another implementation of the second aspect, the identification result may include whether the target object is within a black list or a white list of the access control system. The execution of decision logic based on the identification result to generate a control instruction may include: generating a control instruction for forbidding the open of the access passage in the case that the target object is within the black list of the access control system; and/or generating a control instruction for permitting the open of the access passage in the case that the target object is within the white list of the access control system.

In combination with the second aspect and its implementation above, in another implementation of the second aspect, the access control system may comprise a plurality of access passages, and the data processing method may further include: obtaining the access relevant information of the access passage corresponding to the target object; determining different decision logics for different access passages based on the access relevant information.

In combination with the second aspect and its implementation above, in another implementation of the second aspect, the execution of decision logic to generate a control instruction based on the identification result may include: determining a decision logic corresponding to a verified target object based on the identification result; generating a control instruction using the determined decision logic.

In combination with the second aspect and its implementation above, in another implementation of the second aspect, the data processing method may further include: obtaining a real-time operating information of the access passage; displaying at least one of the real-time operating information of the access passage, an information of the verified target object and a welcome information for the verified target object.

In combination with the second aspect and its implementation above, in another implementation of the second aspect, the obtaining real-time operating information of the access passage may include: obtaining at least one of the real-time information data of the target object and the identification result, as the real-time operating information.

In combination with the second aspect and its implementation above, in another implementation of the second aspect, the data processing method may further include: maintaining user registration information; and maintaining the decision logic and control of the access passage.

In combination with the second aspect and its implementation above, in another implementation of the second aspect, the maintaining user registration information may include querying and updating information related to registered users; the maintaining the decision logic and control of the access passage may include: changing decision logic for every access passage; and adding or deleting an access passage controlled by the access control system.

In a third aspect, a computer program product for the access control system is provided. The computer program product includes a recording medium readable by a computer, on which computer program instructions are stored, which may be executed by a processor to make the processor: obtain real-time information of a target object; identify the target object based on the obtained real-time information data and have an identification result; execute decision logic to generate a control instruction based on the identification result; control operations of the access passage based on the control instruction.

In the technical solutions of the access control system, the data processing method and the computer program product for the access control system according to embodiments of the present disclosure, it is able to safely and conveniently perform identity verification and access control by identifying the target object based on the collected real-time information data of the target object and controlling the operation of the access passage based on the identification result, thereby the user experience is enhanced.

### BRIEF DESCRIPTION OF DRAWINGS

In order to more clearly explain the technical solutions of embodiments of the present disclosure, drawings necessary for the description of embodiments or the prior art are briefly introduced below. Obviously, the drawings described below are merely some embodiments of the present disclosure, a person of ordinary skill in the art can also obtain other drawings according to these drawings.

FIG. 1 schematically illustrates an application scenario of an access control system.

FIG. 2 schematically illustrates a block diagram of a first access control system according to an embodiment of the present disclosure.

FIG. 3 schematically illustrates a block diagram of the identification device of the first access control system in FIG. 2.

FIG. 4 schematically illustrates a block diagram of the access operation device of the first access control system in FIG. 2.

FIG. 5 schematically illustrates a block diagram of a second access control system according to an embodiment of the present disclosure.

FIG. 6 schematically illustrates a first application example of an access control system according to an embodiment of the present disclosure.

FIG. 7 schematically illustrates a second application example of an access control system according to an embodiment of the present disclosure.

FIG. 8 schematically illustrates a flowchart of a first data processing method for an access control system according to an embodiment of the present disclosure.

FIG. 9 schematically illustrates a flowchart of a second data processing method for an access control system according to an embodiment of the present disclosure.

### DETAILED DESCRIPTION

The technical solutions of embodiments of the present disclosure will be described clearly and completely below in combination with the drawings in the embodiments of the present disclosure. Obviously, the described embodiments are some embodiments of the present disclosure, but not all embodiments. Embodiments of the present disclosure and characteristics of the embodiments may be randomly combined to each other in the case without conflict.

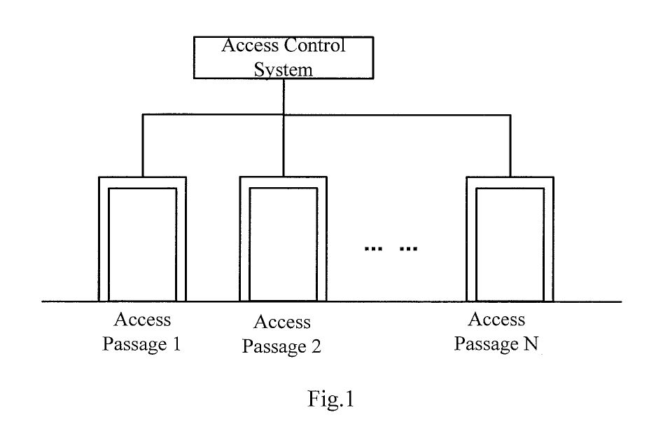

FIG. 1 schematically illustrates an application scenario of an access control system. As shown in FIG. 1, there is typically a plurality of access passages 1, 2, . . . N, each of which is connected to an access control system. An information collection device is set on each access passage to collect information of a person to pass the access passage, such as image information, audio information, video information, and so on, which are then transmitted to the access control system. Based on the information of the person to pass the access passage, the access control system identifies an identity of the person, and controls the access passage based on the verification result. For example, when the access control system determines through verification that the person is a registered user or an authorized user, the access control system opens the access passage where the person is; when the access control system finds out through verification that the person is neither a registered user nor an authorized user, the access control system keeps the access passage closed where the person is.

Every registered user corresponds to one or more of the access passages. For example, every owner of a residence community may be only able to register as corresponding to one access passage; estate management personnel of a residence community may register as corresponding to a plurality of access passages; office staff may register as corresponding to more than one access passage therein. Every registered user can only pass the registered access passage corresponding to him/her. Hereinafter, when the registered user is referred to hereinafter, it always means the registered user of the corresponding access passage. As for other access passages, the registered user of the corresponding access passage is not a registered user any more. The access control system may add access passages, or reduce access passages according to instructions, and may also add registered users corresponding to every access passage or cancel registered users corresponding to every access passage, etc. according to instructions.

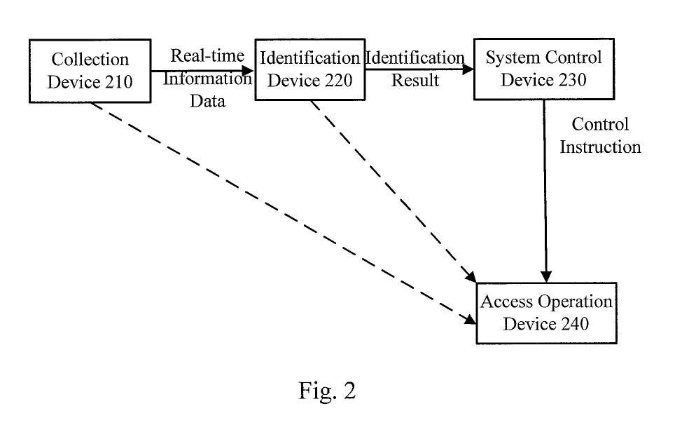

FIG. 2 schematically illustrates a block diagram of a first access control system 200 according to an embodiment of the present disclosure. The first access control system 200 is used for controlling one or more of the access passages in FIG. 1. As shown in FIG. 2, the first access control system 200 includes: a collection device 210 set corresponding to the access passage, for collecting real-time information data of a target object; an identification device 200 for identifying the target object based on the collected real-time information data and user registration information of the access control system, and obtaining an identification result; a system control device 230 for executing a decision logic based on the identification result to generate a control instruction; an access operation device 240 for controlling an operation of the access passage based on the control instruction generated by the system control device.

Typically, the collection device 210 is set corresponding to the access passage shown in FIG. 1. Particularly, one collection device is set near each access passage. The collection device 210 is used for collecting real-time information data of a target object to pass the corresponding access passage. The real-time information data is for example image information, audio information, video information, etc. of the target object. These real-time information data may change with time, and may also change with the place. The real-time information data may reflect a current state of the target object in real time, so as to avoid attacks of malicious users by means of password, duplicated card, duplicated fingerprint, etc.

The real-time information data will be used for identifying an identity of the target object, whose content may change with technology adopted in the identification. For example, when a face recognition technology is adopted to determine the identity of the target object, the real-time information data may be the facial data of the target object; when a voice recognition technology is adopted to determine the identity of the target object, the real-time information data may be the audio data of the target object. Accordingly, the collection device 210 may be a camera for collecting video information data or image information data of the target object; the collection device 210 may also be a recorder for collecting audio information data of the target objet. The implementation of the collection device 210 does not constitute a limitation to the embodiments of the present disclosure.

The identification device 220 is electrically connected to the collection device 210, receives the real-time information data from the collection device 210, identifies the target object based on the real-time information data and the user registration information of the access control system, and obtains an identification result. The User registration information of the access control system may normally comprise identity information of facial data, name (or nickname), position, contact information, etc. of the registered users. The user registration information may be stored locally or in a cloud server. In the case that the collected real-time information data comprises the facial image of the target object, the identification device 220 may identify the target object by means of a face recognition technology. In the case that the collected real-time information data comprises the voice information of the target object, the identification device 220 may identify the target object by means of a voice recognition technology. The identification device 220 may be connected to the collection device 210 by way of wire communication or wireless communication. The identification device 220 may be located in a cloud server, and connected to the collection device 210 via communication network. Or, the identification device 220 may also be located in the same LAN with the collection device 210. Or, the identification device 220 may also be directly connected to the collection device 210, neither of which is connected to the network.

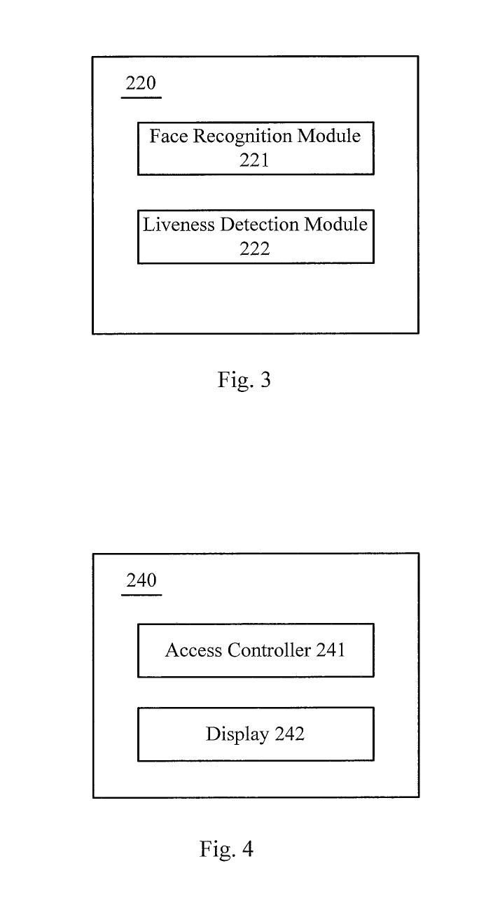

FIG. 3 schematically illustrates a block diagram of the identification device 220 of the first access control system in FIG. 2. In FIG. 3, the identification device 220 identifies a target object based on face recognition technology. As shown in FIG. 3, the identification device 220 may include: a face recognition module 221 for carrying out face recognition for the target object based on the collected real-time information data and the user registration information of the access control system to determine the identity information of the target object; a liveness detection module 222 for carrying out liveness detection based on the real-time information data to determine whether the target object is a living body.

Face recognition is a biometric identification technology for identity recognition based on facial features of a human face. The face recognition module 221 extracts facial feature information of the target object from the collected real-time information data, compares the facial features with facial features of every user in user registration information to determine similarity between the extracted facial feature information of the target object and the facial features of the registered users, and determines the identity information of the target object based on the similarity. The facial features are, for example, position features of key points of human face, such as eyes, nose, mouse, etc. For example, when the similarity between the facial feature information of the target object and the facial features of a specific registered user is larger than a predetermined threshold, the face recognition module 221 may determine that the target object is the specific registered user. If the similarity between the facial feature information of the target object and the facial features of any registered user is less than a predetermined threshold, the face recognition module 221 may determine that the target object is not authorized. Furthermore, in order to store the user registration information, a memory may be set in the identification device 220, or the identification device 220 may be coupled to a memory. The memory stores the user registration information of the access control system.

The liveness detection module 222 carries out the liveness detection based on the real-time information data to determine whether the target object is a living body. Exemplarily, the liveness detection module 222 carries out the liveness detection by judging whether the face of target object is a face of a living body. In an application of the access control system, a malicious user may counterfeit facial movements of a specific user by using a false mask or broadcasting video, animation, etc. to cheat the access control system in the attempt to pass facial identity verification, but the liveness detection module 222 may effectively solve this problem. When the real-time information data collected by the collection device 210 is a false mask, broadcasted video or animation, etc., the liveness detection module 222 may determine that the target object is not a living body; at this time, even if the face recognition module 221 identifies that the target object is Mr. Zhang, the access control system would not determine the target object as Mr. Zhang. For example, the liveness detection module 222 of the present embodiment may adopt the following means to carry out liveness detection: determining whether facial temperature of the target object is close to 37 degree through thermal infrared; analyzing whether ultrasonic reflectivity of the face of the target object is similar to a genuine face through ultrasonic reflection; determining whether the face of the target object is a 3D image through depth image, and so on. Therein, the collection device 210 may comprise a depth camera to collect the depth image of the face of the target object, through which it is able to determine whether the face of the target object is a 3D image, thus determining whether the target object is a living body.

It can be seen that the liveness detection module 222 is only used for enhancing the accuracy of identity recognition, which is an auxiliary means for identifying identity information of the target object. Therefore, when the access control system has relatively low requirement for security, the liveness detection module 222 may be omitted from the identification device 220. Moreover, the liveness detection module 222 may also cooperate with other recognition technologies beside face recognition technology to verify the identity information of the target object.

As an example, the collection device 210 may collect facial movement images of the target object while reading specific text information as real-time information data, and the liveness detection module 222 may determine whether the facial movement among the real-time information data matches with the pronunciation of specific text information, determining that the target object is a living body when the facial movement matches with the pronunciation of specific text information, and that the target object is not a living body when the facial movement does not match with the pronunciation of specific text information. The way, by which the liveness detection module 222 carries out liveness detection, does not constitute limitations to the embodiment of the present disclosure.

The identification device 220 may be implemented by means of a processor and a memory. The memory may comprise program code. When the program code is executed, the processor may determine identity information of the target object and/or determine whether the target object is a living body based on face recognition technology.

The system control device 230 in FIG. 2 carries out decision logic based on the identification result of the identification device 220 to generate a control instruction. The decision logic is a logic rule for generating a control instruction based on the identification result. The decision logic may be preset in the system control device 230, which may further be modified as needed.

In the case that the identification device 220 has a structure as shown in FIG. 2, the identification result may comprise the liveness detection result of the liveness detection module 222 and the face recognition result of the face recognition module 221, and the system control device 230 may carry out the decision logic based on at least one of the liveness detection result and the face recognition result.

When the liveness detection result indicates that the target object is not a living body, the system control device 230 may issue alerting information to the access operation device 240. When the target object is not a living body, there might be a malicious person to pass the access passage, with big potential security hazard, so the access operation device 240 issues the alerting information to prompt for strengthening prevention.

When the identity information determined by face recognition indicates the identity of the target object and the liveness detection result indicates that the target object is not a living body, the system control device 230 may send reminder information to the registered user corresponding to the determined identity information. In this case, it shows that there is some malicious user counterfeiting the registered user having the determined identity information, which might bring potential danger for registered user of the access control system. Users might record their contact information while registering at the access control system, therefore the system control device 230 may send reminder information to the registered user corresponding to the determined identity information. For example, the system control device 230 may be connected to a communication module or have a communication module, via which the reminder information may be sent to the mobile phone of the registered user corresponding to the determined identity information. The system control device 230 may adopt an appropriate device to send the reminder information, depending on contact information of the registered user.

As depicted in combination with FIG. 1, the access control system may comprise a plurality of access passages. At this time, the identification device 220 may obtain access relevant information of the access passage corresponding to the target object, and transmit the access relevant information to the system control device 230. The access relevant information is for example a product model, an access number, etc. corresponding to the access passage. Based on the access relevant information, the system control device 230 is able to identify the access passage. Accordingly, the system control device 230 carries out different decision logics for different access passages based on the access relevant information. The control instructions typically are to open the access passage, to keep the access passage closed, and to issue an alert, etc. For example, the system control device 230 carries out a first decision logic for the access passage 1, and carries out a second decision logic, different from the first decision logic, for the access passage 2.

Suppose that a registered user corresponding to the access passage 1 pays more emphasis on safety and privacy, who wishes to screen strictly person who will pass the access passage 1. The system control device 230 may generate a control instruction based on the first decision logic. Under the first decision logic, when the identification result indicates that the target object is one of the registered users corresponding to the access passage 1 and the target object is a living body, the system control device 230 generates a control instruction for opening the access passage 1; when the identification result indicates that the target object is not one of the registered users corresponding to the access passage 1 and the target object is a living body, the system control device 230 generates a control instruction for keeping the access passage 1 closed; when the identification result indicates that the target object is not one of the registered users corresponding to the access passage 1 and the target object is not a living body, the system control device 230 generates a control instruction for keeping the access passage 1 closed and issuing an alert.

Suppose that the access passage 2 is an access used for an ordinary residential unit, which has relatively low requirement for the person who can enter safely. The system control device 230 may generate a control instruction based on the second decision logic. Under the second decision logic, when the identification result indicates that the target object is one of the registered users corresponding to the access passage 2, the system control device 230 generates a control instruction for opening the access passage 2, no matter whether the target object is a living body or not; when the identification result indicates that the target object is not one of the registered users corresponding to the access passage 2, the system control device 230 generates a control instruction for keeping the access passage 2 closed.

Furthermore, the system control device 230 may also carry out different decision logics for different registered users of the access control system. For example, the system control device 230 carries out a decision logic A for the registered user A, and a decision logic B, different from the decision logic A, for the registered user B.

Suppose that the registered user A has visitors during a predetermined period, and wishes to allow visitors to pass the access passage A corresponding to him/her with his/her photo during the predetermined period. Accordingly, under the decision logic A, during the predetermined period set by the registered user A, when the identification result indicates that the target object in front of the access passage A is the registered user A, the system control device 230 generates a control instruction for opening the access passage A, no matter whether the target object is a living body or not; when the identification result indicates that the target object in front of the access passage A is not the registered user A, the system control device 230 generates a control instruction for keeping the access passage A closed, no matter whether the target object is a living body or not.

Suppose that the registered user B has been impersonated by a malicious person to enter the corresponding access passage B, who wishes to strengthen prevention by means of the decision logic B. Accordingly, under the decision logic B, when the identification result indicates that the target object in front of the access passage B is the registered user B and is a living body, the system control device 230 generates a control instruction for opening the access passage B; when the identification result indicates that the target object in front of the access passage B is the registered user B but is not a living body, the system control device 230 generates a control instruction for keeping the access passage B closed and issuing an alert.

The system control device 230 may be implemented by means of a processor and a memory. The memory may comprise program code. When the program code is executed, the processor may generate a control instruction based on the identification result.

In an example, the system control device 230 may also perform a functionality of limiting access time, i.e. during a specific period (e.g., non-business hours of a site with the access control system installed), the system control device 230 always generates a control instruction of keeping the access passage closed, without carrying out decision logic based on the identification result. That is, during the specific period, even if the target object is one of the registered users corresponding to the access passage and is a living body, the access control system would still keep closed. Since the system control device 230 may carry out the functionality of limiting the access time, the security of the access control system during the specific period (e.g. no-business hours) may be improved.

In another example, the system control device 230 may further perform a functionality of black list or a functionality of white list. Particularly, user registration information of the access control system also comprises at least one of a black list and a white list, and it is possible to start or shut down the functionality of black list and the functionality of white list by the system control device 230 as needed. The white list includes for example at least part of the registered users corresponding to every access passage of the access control system, such as corporate executives, corporate VIP customers, etc. The black list includes for example people who have once requested for passing the access passage but not been identified as registered users of the access passage. As the identification result, the identification device 220 may identify whether the target object is in the black list or the white list of the access control system. When the functionality of black list is enabled, in a case that the target object is in the black list of the access control system, the system control device 230 may generate a control instruction for forbidding the open of the access passage; and when the target object is a registered user out of the black list, the system control device 230 generates a control instruction for permitting the open of the access passage. When the functionality of white list is enabled, in a case that the target object is in the white list of the access control system, the system control device 230 may generate a control instruction for permitting the open of the access passage; and when the target object is a registered user out of the white list, the system control device 230 generates a control instruction for forbidding the open of the access passage. The security of the access control system may be further improved by setting the functionality of black list or the functionality of white list.

The access operation device 240 of the access control system in FIG. 2 controls operations of the access passage based on control instructions generated by the system control device 230. For example, when the control instruction indicates forbidding the open of the access passage, the access operation device 240 keeps the access passage closed; when the control instruction indicates opening the access passage, the access operation device 240 opens the access passage; when the control instruction indicates issuing an alert information, the access operation device 240 issues an alert.

FIG. 4 schematically illustrates a block diagram of the access operation device 240 of the first access control system in FIG. 2. As shown in FIG. 4, the access operation device 240 includes: an access controller 241 for controlling the opening and closing operation of the access passage based on the control instruction; a display 242 for displaying at least one of the real-time operating information of the access passage, information of the verified target object and welcome information for the verified target object.

The real-time operating information displayed by the display 242 may comprise at least one of the real-time information data collected by the collection device 210 and the identification result of the identification device 220. As shown in FIG. 2, the collection device further transmits the real-time operating information to the identification device. In a case that the real-time information data comes from the collection device 210, the access operation device 240 is connected to the collection device 210; in a case that the real-time information data comes from the identification device 220, the access operation device 240 is connected to the identification device 220, as shown in FIG. 2 in dashed lines having arrows. The identification device 220 further transmits the identification result to the system control device 230. The access operation device 240 may receive the identification result from the identification device 220 or the system control device 230. The information of the verified target object is for example at least one of the photo, name, position, etc. of the target object. The welcome information is for example “Good Morning”, “Welcome”, “Happy Birthday” etc. The display 242 enriches services for users, therefore enhancing user's experience. The access operation device 240 operates under the control of the system control device 230, so the access operation device 240 may obtain the information of the verified target object and the welcome information from the system control device 230. The information of the verified target object and the welcome information may be set or modified by users.

Furthermore, when the alerting information comprises a voice prompt information, the access operation device 240 may also comprise a speaker, or be connected to a speaker, issuing the alerting information via the speaker. When the alerting information comprises a prompt information of flashing light, the access operation device 240 may comprise a lighting device, or be connected to a lighting device, and controls flashing of the lighting device to issue the alerting information. The particular implementation of the access operation device 240 may change according to the operation performed by it.

The access operation device 240 may be implemented by means of a processor and a memory. The memory may comprise program code. When the program code is executed, the processor may control operations of the access passage based on the control instruction.

In the technical solution according to the embodiment of the present disclosure, it is able to safely and conveniently perform identity verification and access control by identifying the target object based on the collected real-time information data of the target object and controlling the operation of the access passage based on the identification result, thereby the user experience are enhanced.

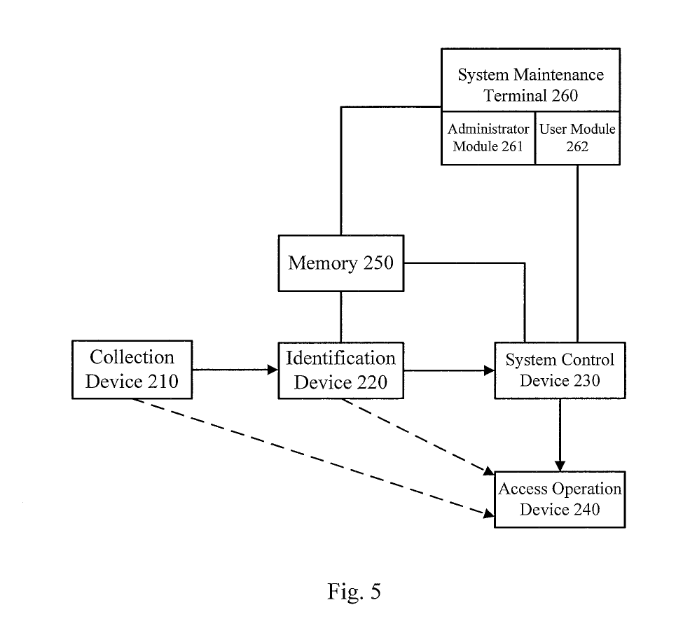

FIG. 5 schematically illustrates a block diagram of a second access control system 500 according to an embodiment of the present disclosure. A collection device 210, a system control device 230 and an access operation device 240 in the second access control system 500 in FIG. 5 are the same as the corresponding devices in the first access control system 200 in FIG. 2, and can be referred to previous description in combination with FIG. 2 to FIG. 4. A difference between the second access control system 500 in FIG. 5 and the first access control system 200 in FIG. 2 lies in that a memory 250 and a system maintenance terminal 260 are added.

As shown in FIG. 5, the memory 250 is connected to the identification device 220 and the system control device 230, for storing user registration information of the access control system. As described above, the user registration information may comprise facial feature data of registered users, thus the target object is identified by the identification device 220. Furthermore, in the case that the access operation device is to display the information of the verified target object and the welcome information, the user registration information may also comprise the user relevant information of photo, name, position, contact information, etc. of the registered user, as well as the welcome information corresponding to the registered user. One or more of the user relevant information may be displayed as information of the verified target object. If necessary, the welcome information may also be provided to the access operation device 240 via the system control device to display.

In FIG. 5, a separate memory 250 is set to store user registration information, to which the identification device 220 and the system control device 230 are connected to achieve required information. However, as described above, it is also possible to store user registration information separately. For example, the information for identifying the object in user registration information is stored in the identification device 220, and the user relevant information and the welcome information and the like are stored in the system control device 230.

The system maintenance terminal 260 in FIG. 5 is for example a computer, a laptop, a smart phone, a tablet, etc. By means of the system maintenance terminal 260, it is able to maintain user registration information, and the control of the access operation device by the system control device. As an example of maintenance of user registration information, the system maintenance terminal 260 may perform at least one of the following operations: adding new registered users for the access control system, deleting registered users, querying registered users, and modifying user registration information of registered users. As an example of the control of the access operation device by the system control device, the system maintenance terminal 260 may perform at least one of the following operations: adding to the system control device 230 new access passages to be controlled, deleting controlled access passage(s), modifying the decision logic of the controlled access passages, and querying related information of the controlled access passages.

As shown in FIG. 5, the system maintenance terminal 260 may include: an administrator module 261 for modifying the decision logic of the system control device, maintaining information display of the access operation device, querying user registration information, and maintaining user registration information; a user module 262 for accessing login information of a specific user, and modifying the identify information of the specific user. A registered user A may access its own login information of logging in to the access control system via the user module 262; may modify its own user relevant information, such as its photo, name, position, and so on; may also modify its welcome information and the like. However, the registered user A can neither access login information of other registered users in the access control system, nor modify user relevant information or welcome information of other registered users in the access control system. The administrator module 261 may have high administrative authority, who can manage user registration information of every registered user of the access control system. By means of the system maintenance terminal 260, it is able to improve adaptability and scalability of the access control system.

It should be noted that various devices in the access control system in FIG. 2 and FIG. 5 may be separate devices, and put in different positions in space. For example, the collection device 210 is positioned near the access passage; the identification device 220 may be located in the cloud and connected with other devices of the access control system through the Internet, or in other positions separate from the space of the collection device 210; the system control device 230 may also be located in the cloud and connected with other devices of the access control system through the Internet, or in other positions separate from the space of the collection device 210 and the identification device 220, or close in space to the identification 220; the access operation device 240 may be located in other positions separate from any of the collection device 210, the identification device 220 and the system control device 230, or close to one of the identification device 220 and the system control device 230. The space positions of various devices of various access control systems do not constitute limitations to embodiments of the present disclosure.

In application, at least one of the identification device 220 and the system control device 230 can be deployed online or offline as needed. When the identification device 220 is deployed online, a pressure of offline computing may be reduced, which is suitable for the application scenario in which the offline computing power is weak. When the identification device 220 is deployed offline, it may further protect data security and reduce a pressure of network data transmission. When the system control device 230 is deployed online, it may be more convenient to perform the control of the access control system. When the system control device 230 is deployed offline, data breaches of the access control system may be prevented, thereby improving the security.

Furthermore, in the case that various devices of the access control system are separate in space, the devices separate from each other may convey information through wire connection, and may also convey information through wireless signals. In the latter case, a communication module is included respectively within each device connected through wireless signals, so as to perform information transmission.

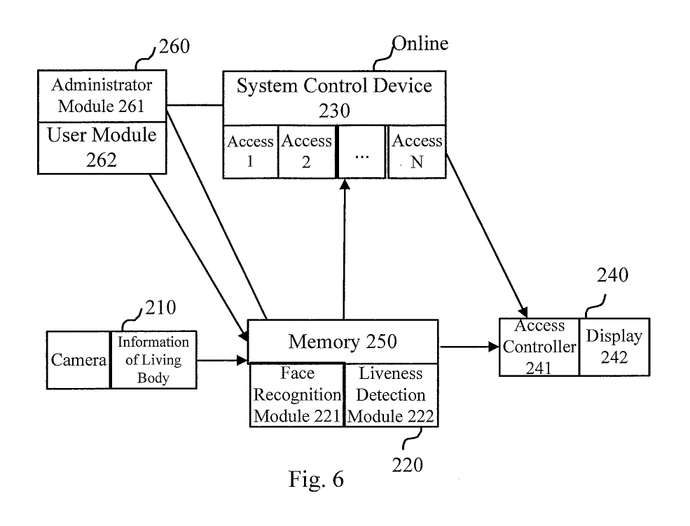

FIG. 6 schematically illustrates a first application example of the access control system according to the embodiment of the present disclosure. As shown in FIG. 6, the collection device 210, the identification device 220 and the operation device 240 are offline modules, and the system control module 230 is an online module and lies in the cloud. The system control device 230 performs a series of interactions with the identification device 220 and the access operation device 240 by means of a virtual medium of Internet and the like. A memory 250 may be located in the identification device 220.

The collection device 210 collects real-time information data of a target object, which is then transmitted to the identification device 220. The real-time information data is for example video information and living body authentication information. The collection device 210 further transmits corresponding access relevant information to the identification device 220.

The face recognition module 221 in the identification device 220 carries out face detection and feature extraction with respect to the received real-time information data, and achieves the face recognition result by comparing with user registration information in the memory 250. The liveness detection module 222 in the identification device 220 carries out liveness detection based on the living body authentication information received from the collection device 210, and gives a liveness detection result. Thereafter, the identification device 220 transmits the face recognition result, the liveness detection result and the access relevant information received from the collection device 210 to the system control device 230. Furthermore, the identification device 220 transmits the video information received from the collection device 210, the face recognition result and the liveness detection result to the access operation device 240.

Based on the access relevant information, the face recognition result and the liveness detection result, the system control device 230 carries out decision logic and generates a control instruction, which is then send to the access operation device 240. The system control device 230 may manage accesses 1, 2, . . . N, respectively corresponding to the access passages 1, 2, . . . N, and carry out different decision logics with respect to different accesses, and may also carry out different decision logics with respect to different registered users.

An access controller 241 in the access operation device 240 controls the operation of the access passage according to the control instruction of the control device 230. Particularly, the access controller 241 opens the door for persons in the white list, and keeps the door closed for those in the black list and issues alerting information. A display 242 in the access operation device 240 displays the video information, the face recognition result and the liveness detection result received from the identification device 220, and may also display welcome information for the verified important users in the access control system.

The above is a brief operation procedure of an access control system. In daily operations, a system maintenance terminal 260 may be employed to maintain the access control system. An administrator module 261 in the system maintenance terminal 260 is connected to the system control device 230 and the memory 250, managing the access controlled by the system control device 230, modifying the decision logic of the system control device, maintaining information display of the access operation device, querying user registration information, and maintaining user registration information. A user module 262 in the system maintenance terminal 260 is connected to the memory 250, accesses login information of a specific user and modifies the identity information of the specific user.

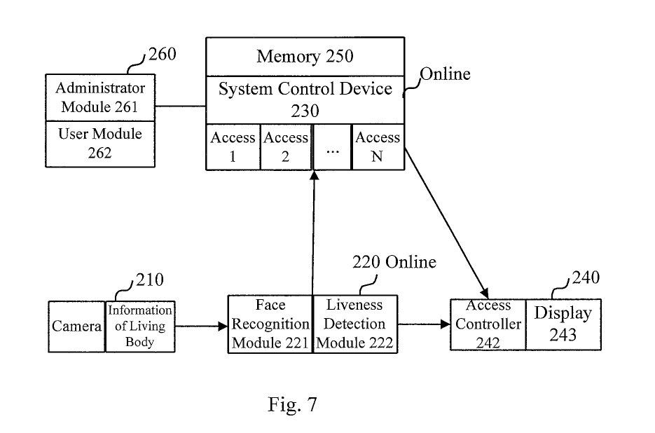

FIG. 7 schematically illustrates a second application example of the access control system according to the embodiment of the present disclosure. As shown in FIG. 7, the collection device 210 and the access operation device 240 are offline modules, and the identification device 220 and the system control device 230 are online modules and are in the cloud. Any of the identification device 220 and the system control device 230 performs a series of interactions with other devices in the access control system by means of the virtual medium of Internet and the like. The memory 250 may be located in the system control device 230.

The collection device 210 collects real-time information data of a target object, which is then transmitted to the identification device 220. The real-time information data is for example video information and living body authentication information. The collection device 210 further transmits corresponding access relevant information to the identification device 220.

The face recognition module 221 in the identification device 220 carries out face detection and feature extraction with respect to the received real-time information data, and achieves the face recognition result by comparing with user registration information in the memory 250. The liveness detection module 222 in the identification device 220 carries out liveness detection and gives the liveness detection result based on living body authentication information received from the collection device 210. Thereafter, the identification device 220 transmits the face recognition result and the liveness detection result to the system control device 230. Furthermore, the identification device 220 transmits the video information received from the collection device 210, the face recognition result and the liveness detection result to the access operation device 240.

The system control device 230 and the access operation device 240 are identical to those in FIG. 6, which will not be described any more.

The above is an operation procedure of the access control system. In daily operations, the system maintenance terminal 260 may be employed to maintain the access control system. The administrator module 261 in the system maintenance terminal 260 is connected to the system control device 230 and the memory 250, manages the access controlled by the system control device 230, modifies the decision logic of the system control device, maintains the information display of the access operation device, queries user registration information, and maintains user registration information. A user module 262 in the system maintenance terminal 260 is connected to the memory 250, accesses login information of a specific user and modifies the identity information of the specific user. At this time, the system maintenance terminal 260 needs not to be connected to the identification device 220, but merely connected to the system control device 230.

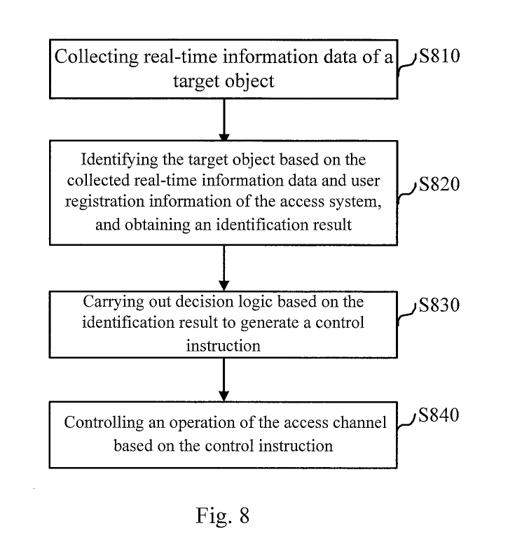

FIG. 8 schematically illustrates a flowchart of a first data processing method 800 for an access control system according to an embodiment of the present disclosure. As shown in FIG. 8, the first data processing method 800 includes: collecting real-time information data of a target object (S810); identifying the target object based on the collected real-time information data and the user registration information of the access control system, and obtaining an identification result (S820); carrying out decision logic to generate a control instruction based on the identification result (S830); controlling an operation of the access passage based on the control instruction (S840).

In S810, real-time information data of a target object to pass the access passage shown in FIG. 1 is collected. The S810 may be implemented by the collection device 210 in FIG. 2. The real-time information data is for example image information, audio information, video information, etc. of the target object. These real-time information data may change with time, and may also change with place. The real-time information data may reflect in real time a current state of the target object, thereby avoiding attacks of malicious users with password, duplicated card, duplicated fingerprint, etc. The real-time information data will be used for identifying an identity of the target object, whose content may change with the technology adopted in the identification. For example, when face recognition technology is adopted to determine the identity of the target object, the real-time information data may be a facial data of the target object; when voice recognition technology is adopted to determine the identity of the target object, the real-time information data may be an audio data of the target object.

In S820, the target object is identified based on real-time information data and user registration information of the access control system, with an identification result achieved. The S820 may be implemented by the identification device 220 in FIG. 2.

In the case that the collected real-time information data comprises the facial image of the target object, face recognition may be performed to the target object based on the collected real-time information data in S820, to determine the identity information of the target object. As an example, the facial feature information of the target object is extracted from the collected real-time information data, which is compared with the facial feature of each user in user registration information, to determine similarity between the two, based on which the identity information of the target object is determined. When the similarity between the facial feature information of the target object and that of a specific registered user is larger than a predetermined threshold, it can be determined that the target object is the specific registered user. If the similarity between the facial feature information of the target object and that of any registered user is less than the predetermined threshold, then it can be determined that the target object is not authorized. Or, in a case that the collected real-time information data comprises voice information of the target object, voice recognition technology may be employed in S820 to identify the target object.

In an example, the access control system may include at least one of a black list and a white list. The white list includes for example at least part of the registered users corresponding to each access passage in the access control system, such as corporate executives, corporate VIP customers, etc. The black list includes for example a person who had once requested for passing the access passage but had not been identified as registered users of the access passage. In S820, it is able to identify whether the target object is in the black list or the white list of the access control system, which will be comprised in the identification result.

Furthermore, in S820 the following may also be included: carrying out liveness detection to the target object based on the collected real-time information data, to determine whether the target object is a living body. A malicious user may counterfeit facial movements of a specific user by means of a false mask or broadcasting video, animation, etc., to cheat face identify verification. When the collected real-time information data in S810 is a false mask, broadcasted video or animation, etc., it may be determined by the liveness detection that the target object is not a living body. Thus, even if it is identified that the target object is Mr. Zhang, the access control system would not determine the target object as Mr. Zhang. The liveness detection is only used for enhancing the accuracy of identity recognition, which is an auxiliary means for identifying identity information of the target object. When the access control system has relatively low requirement for security, the liveness detection operation may not be carried out in S820. Moreover, the liveness detection may also cooperate with other recognition technologies besides face recognition technology to verify identity information of the target object. As an example of liveness detection, facial movement images of the target object who is reading specific text information may be collected in S810, and it may be determined in S820 whether the facial movement among the facial movement images matches with a pronunciation of specific text information, the target object is determined as a living body when the facial movement matches with the pronunciation of specific text information, while the target object is not determined as a living body when the facial movement does not match with the pronunciation of specific text information. The way of liveness detection does not constitute limitations to embodiments of the present disclosure.

In S830 of FIG. 8, decision logic is carried out based on the identification result in S820, to generate a control instruction. The decision logic is a logic rule for generating a control instruction based on the identification result. The control instructions typically are to open the access passage, to keep the access passage closed, to issue an alert, etc. The S830 may be implemented by the system control device 230 in FIG. 2.

In a case that the identification result indicates that the target object is within the black list of the access control system, a control instruction for forbidding open of the access passage is generated in S830. In a case that the identification result indicates that the target object is within the white list of the access control system, a control instruction for permitting the open of the access passage is generated in S830.

In the case that the liveness detection result and the face recognition result are included in the identification result, decision logic is carried out based on at least one of the liveness detection result and the face recognition result in S830. As an example, when the liveness detection result indicates that the target object is not a living body, alerting information may be issued in S830 for prompting a presence of malicious users. When the target object is not a living body, there might be a malicious user to pass the access passage, with big potential security hazard, so the alerting information is issued in S830 to prompt for strengthening prevention. As another example, when the identity information determined through face recognition indicates the identity of the target object and the liveness detection result indicates that the target object is not a living body, a reminder information may be issued in S830 to a registered user corresponding to the determined identity information. In this case, it shows that there is a malicious user counterfeiting the registered user having the determined identity information, which may bring potential hazard to the registered user in the access control system. Users may record their contact information when registering at the access control system, therefore the reminder information may be issued in S830 to the registered users corresponding to the determined identity information.

Furthermore, different decision logics may be carried out in S830 with respect to different registered users of the access control system. Accordingly, the decision logic corresponding to the verified target object may be determined based on the identification result; and a control instruction is generated by the determined decision logic. For example, in S830, a decision logic A may be determined for a registered user A, and a decision logic B different from the decision logic A may be determined for a registered user B.

Suppose that the registered user A has visitors during a predetermined period, and wishes to allow visitors to pass the access passage A corresponding to him/her with his/her photo during the period. Accordingly, under the decision logic A, during the predetermined period set by the registered user A, when the identification result indicates that the target object in front of the access passage A is the registered user A, a control instruction for opening the access passage A is generated in S830; when the identification result indicates that the target object in front of the access passage A is not the registered user A, a control instruction for keeping the access passage A closed is generated in S830. Suppose that the registered user B has once been impersonated by a malicious person to enter the corresponding access passage B, who wishes to strengthen prevention by means of the decision logic B. Accordingly, under the decision logic B, when the identification result indicates that the target object in front of the access passage B is the registered user B and is a living body, a control instruction for opening the access passage B is generated in S830; when the identification result indicates that the target object in front of the access passage B is the registered user B but is not a living body, a control instruction for keeping the access passage B closed and issuing an alert is generated in S830.

In S840 of FIG. 8, the operation of the access passage is controlled based on the control instruction generated in S830. For example, when the control instruction indicates forbidding the open of the access passage, the access passage is kept closed in S840; when the control instruction indicates opening the access passage, the access passage is opened in S840; when the control instruction indicates issuing an alert, an alert is issued in S840. The S840 may be implemented by the access operation device 240 in FIG. 2, and can be referred to the illustration of FIG. 2 and FIG. 4 and related description.

Furthermore, when the alerting information comprises a voice prompt information, a speaker of the access control system may be controlled to issue the alerting information in S840. When the alerting information comprises prompt information of flashing light, a lighting device of the access control system may be controlled to issue the alerting information in S840.

In the technical solution according to the embodiment of the present disclosure, it is able to safely and conveniently perform identity verification and access control by identifying the target object based on the collected real-time information data of the target object and controlling operations of the access passage based on the identification result, thereby enhancing the user experience.

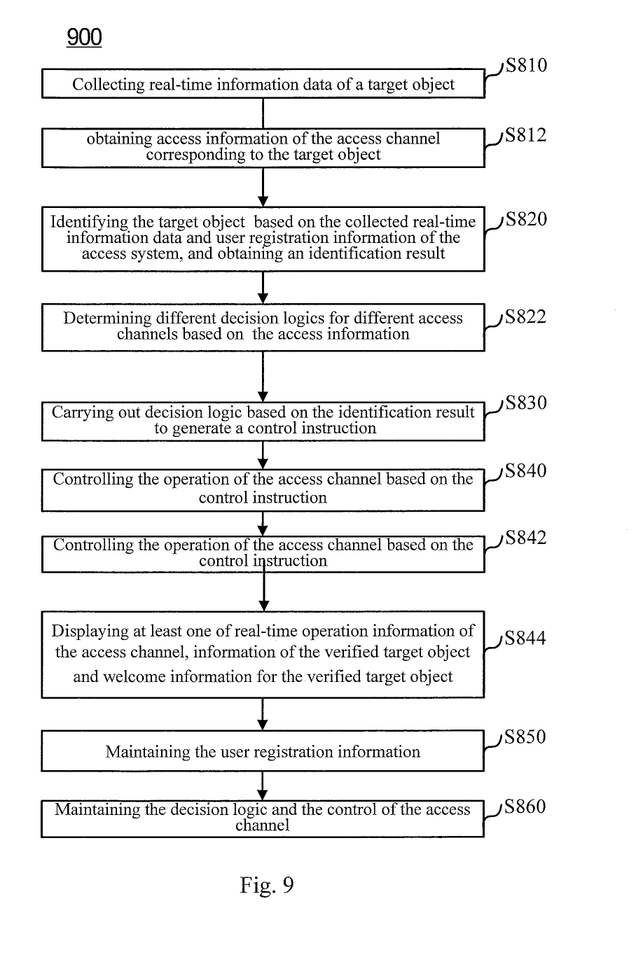

FIG. 9 schematically illustrates a flowchart of a second data processing method 900 for an access control system according to an embodiment of the present disclosure. S810 to S840 in the second data processing method 900 in FIG. 9 are identical to those of the first data processing method 800 in FIG. 8, and can be referred to the illustration of FIG. 8 and the description in combination with FIG. 8.

The difference between the second data processing method 900 in FIG. 9 and the first data processing method 800 in FIG. 8 lies in that steps S812, S822, S842, S844, S850 and S860 are added. Using S812 and S822, different decision logics may be carried out with respect to different access passages in the access control system, thereby the control function of the access control system is enhanced. Using S842 and S844, the real-time operation of the access control system may be displayed, and personalized services may be provided to different registered users. Using S850 and S860, it is allowed to update and maintain the access control system, so as to enhance its adaptability and scalability.

As shown in FIG. 9, S810 is followed by achieving the access information of the access passage corresponding to the target object (step S812). As depicted in combination with FIG. 1, the access control system may include a plurality of access passages. At this time, access information of the access passage corresponding to the target object may be achieved in S812. The access information is for example a product model, an access number, etc. corresponding to the access passage. Based on the access information, it is able to identify the access passage. Accordingly, before the execution of S830, different decision logics may be determined for different access passages based on the access information (step S822). Thus, in S830, the determined decision logic may be carried out to generate a control instruction. For example, in S822, a first decision logic is determined for the access passage 1, and a second decision logic, which is different from the first decision logic, is determined for the access passage 2. The S822 may be implemented by the system control device in FIG. 2. The S812 may be implemented at the same time as S810, or prior to it.

Suppose that a registered user corresponding to the access passage 1 pays more emphasis on safety and privacy, and wishes to screen strictly a person to pass the access passage 1. A first decision logic is determined for the access passage 1 in S822. Under the first decision logic, when the identification result indicates that the target object is one of the registered users corresponding to the access passage 1 and the target object is a living body, a control instruction is generated in S830 for opening the access passage 1; when the identification result indicates that the target object is not one of the registered users corresponding to the access passage 1 and the target object is a living body, a control instruction is generated in S830 for keeping the access passage 1 closed; when the identification result indicates that the target object is not one of the registered users corresponding to the access passage 1 and the target object is not a living body, a control instruction is generated in S830 for keeping the access passage 1 closed and issuing an alert.

Suppose that the access passage 2 is used for an access of an ordinary residential unit, which has relatively low requirement for a person who can get entered safely. A second decision logic is determined for the access passage 2 in S822. Under the second decision logic, when the identification result indicates that the target object is one of the registered users corresponding to the access passage 2, a control instruction is generated in S830 for opening the access passage 2, no matter whether the target object is a living body or not; when the identification result indicates that the target object is not one of the registered users corresponding to the access passage 2, a control instruction is generated for keeping the access passage 2 closed in S830.

In S842, real-time operating information of the access passage is achieved. The real-time operating information may include at least one of the collected real-time information data in S810 and the identification result in S820. In S844, at least one of the real-time operating information of the access passage, the information of the verified target object, and the welcome information for the verified target object are displayed. The information of the verified target object is for example at least one of photo, name, position, etc. of the target object. The welcome information is for example “Good Morning”, “Welcome”, “Happy Birthday”, etc. The service for users is enriched by the S844, therefore enhancing the user experience. Here, S842 is shown as following S840, which is merely exemplary. For example, real-time information data in real-time operating information may be achieved at the same time as S810 or after S810, and the identification result in real-time operating information may be achieved at the same time as S820 or after S820. S844 is usually implemented at the same time as S840. The S844 may be implemented by the display 242 in FIG. 4.

In S850, the user registration information is maintained. In S860, the decision logic and the control for the access passage is maintained. The S850 and the S860 may be implemented by the system maintenance terminal 260 in FIG. 5. As an example of maintenance of the user registration information, S850 may include at least one of the following operations: adding a new registered user for the access control system, deleting a registered user, querying a registered user, and modifying user registration information of a registered user. As an example of maintenance of the decision logic and the control of the access passage, S860 may include at least one of the following operations: adding to the access control system new access passages to be controlled, deleting the controlled access passages, modifying the decision logic of the controlled access passages, and querying relevant information of the controlled access passages. Using S850 and S860, an administrator may change the decision logic of the system control device, maintain information display of the access operation device, query the user registration information, and maintain the user registration information; a specific registered user may access his/her own login information and modify his/her identity information, but may not access or modify information of other registered users. The administrator may have high authority, who may manage user registration information of every registered user of the access control system. Furthermore, S850 and S860 may be performed at any time as needed, without being limited by execution order in FIG. 9.

Those of ordinary skill in the art may realize that the units and algorithm steps of every example in combination with the description of disclosed embodiments in this paper can be implemented by electronic hardware, or the combination of computer software and electronic hardware. It depends on a specific application and design constraints of technical solutions that whether these functionalities are implemented by hardware or software. Those skilled in the art may adopt different methods for every specific application to implement the described functionalities. But such implementation should not be considered as exceeding a scope of the present disclosure.

In several embodiments provided in the present application, it should be understood that the exposed apparatus and methods may be implemented by other ways. For example, the embodiments described above are merely exemplary, for example, the division of the units is merely one kind of logic function division, other ways of division are available in practice, for example, a plurality of units and components may be combined or integrated into another apparatus, or some characteristics may be ignored or not implemented.

What is described above is merely a specific implementation of the present disclosure, but the protection scope of the present disclosure is not limited to it, and any of those skilled in the art may readily think of variations or alternatives, which should be contained in the protection scope of the present disclosure. Therefore, the protection scope of the present disclosure should be in accordance with the claimed protection scope.

1. An access control system, comprising:
a collection device set corresponding to an access passage, for collecting an real-time information data of a target object;
an identification device for identifying the target object based on the collected real-time information data and user registration information of the access control system, and obtaining an identification result;
a system control device for carrying out a decision logic based on the identification result to generate a control instruction;
an access operation device for controlling an operation of the access passage based on the control instruction generated by the system control device.

2. The access control system of claim 1, wherein the identification device comprises:
a face recognition module for carrying out face recognition for the target object based on the collected real-time information data and the user registration information of the access control system, to determine an identity information of the target object.

3. The access control system of claim 2, wherein the identification device further includes:
A liveness detection module for carrying out liveness detection based on the real-time information data to determine whether the target object is a living body.

4. The access control system of claim 2, wherein the system control device carries out the decision logic based on at least one of the liveness detection result of the liveness detection module and the face recognition result of the face recognition module,
wherein when the liveness detection result indicates that the target object is not a living body, the system control system issues an alerting information to the access operation device; and/or
when the identified identity information indicates an identity of the target object and the liveness detection result indicates that the target object is not a living body, the system control device sends reminder information to a registered user corresponding to the determined identity information.

5. The access control system of claim 1, wherein the identification result comprises whether the target object is included in a black list or a white list of the access control system,
the system control device generates a control instruction for forbidding an open of the access passage in a case that the target object is in the black list of the access control system, and/or generates a control instruction for permitting the open of the access passage in a case that the target object is in the white list of the access control system.

6. The access control system of claim 1, wherein,
there are a plurality of access passages;
the identification device obtains an access relevant information of the access passage corresponding to the target object, and transmits the access relevant information to the system control device;
the system control device carries out different decision logics with respect to different access passages based on the access relevant information.

7. The access control system of claim 1, wherein
the system control device carries out different decision logics for different registered users of the access control system; and/or
the system control device always generates a control instruction of keeping the access passage closed during a specific period, without carrying out the decision logic based on the identification result any more.

8. The access control system of claim 1, wherein the access operation device includes:
an access controller for controlling an opening operation and closing operation of the access passage based on the control instruction;
a display for displaying at least one of a real-time operating information of the access passage, an information of a verified target object and a welcome information for a verified target object.

9. The access control system of claim 1, further including:
a memory for storing an user registration information of the access control system;
a system maintenance terminal for maintaining the user registration information and maintaining a control of the access operation device by the system control device.

10. The access control system of claim 9, wherein the system maintenance terminal includes:
an administrator module for changing the decision logic of the system control device, maintaining information display of the access operation device, querying the user registration information, and maintaining the user registration information;
a user module for accessing login information of a specific user and modifying identity information of the specific user.

11. A data processing method for the access control system, comprising:
collecting an real-time information data of a target object;
identifying the target object based on the collected real-time information data and an user registration information of the access control system, and obtaining an identification result;
executing a decision logic based on the identification result to generate a control instruction;
controlling an operation of the access passage based on the control instruction.

12. The data processing method of claim 11, wherein the identifying the target object based on the collected real-time information data includes:
carrying out a face recognition for the target object based on the collected real-time information data, to determine a identity information of the target object.

13. The data processing method of claim 12, wherein the identifying the target object based on the collected real-time information data further includes:
carrying out liveness detection for the target object based on the collected real-time information data, to determine whether the target object is a living body.

14. The data processing method of claim 12, wherein the executing the decision logic based on the identification result to generate the control instruction includes at least one of the following operations:
issuing an alert information for prompting a presence of a malicious user when the target object is not a living body; and
sending a reminder information to the registered user corresponding to the determined identity information when the determined identity information indicates a identity of the target object and the liveness detection result indicates that the target object is not a living body.

15. The data processing method of claim 11, wherein
the identification result comprises whether the target object is included in a black list or a white list of the access control system, and
the executing the decision logic based on the identification result to generate the control instruction includes:
generating a control instruction for forbidding an open of the access passage in a case that the target object is in the black list of the access control system; and/or
generating a control instruction for permitting the open of the access passage in a case that the target object is in the white list of the access control system.

16. The data processing method of claim 11, wherein the access control system comprises a plurality of access passages, and the data processing method further includes:
achieving an access relevant information of the access passage corresponding to the target object;
carrying out different decision logics for different access passages based on the access relevant information.

17. The data processing method of claim 11, wherein the executing the decision logic based on the identification result to generate the control instruction includes:
determining a decision logic corresponding to a verified target object based on the identification result;
generating the control instruction by using the determined decision logic.

18. The data processing method of claim 11, further including:
obtaining real-time operating information of the access passage;
displaying at least one of the real-time operating information of the access passage, an information of the verified target object and an welcome information for the verified target object.

19. The data processing method of claim 11, further including:
maintaining the user registration information; and
maintaining the decision logic and the control of the access passage.

20. The data processing method of claim 19, wherein the maintaining the user registration information includes: querying and updating information related to the registered users, and the maintaining the decision logic and the control of the access passage includes:
changing decision logics for various access passages; and
adding or deleting an access passage controlled by the access control system.
